(19) United States
(12) Patent Application Publication
(10) Pub. No.: US 2007/0175502 A1
(43) Pub. Date: Aug. 2, 2007

(54) Apparatus and method for delivering acoustic energy through a liquid stream to a target object for disruptive surface cleaning or treating effects

(75) Inventors: John W. Sliwa, Los Altos, CA (US); Carol A. Tosaya, Los Altos, CA (US)

Correspondence Address: David W. Collins - Intellectual Property Law, Suite 100, 512 E. Whitehouse Canyon Road, Green Valley, AZ, 85614, US

(73) Assignee: I.P. Foundry, Inc.

(21) Appl. No.: 11/729,567

(22) Filed: Mar. 28, 2007

Related U.S. Application Data
(63) Continuation-in-part of application No. 11/193,958, filed on Jul. 28, 2005.
(60) Provisional application No. 60/786,861, filed on Mar. 28, 2006.
(60) Provisional application No. 60/592,593, filed on Jul. 30, 2004.

(51) Int. Cl. B08B 3/00; B08B 3/12

(52) U.S. Cl. 134/184; 134/137; 134/94.1; 134/99.1

(57) ABSTRACT

Apparatus is provided for performing acoustically aided treatment or cleaning of workpieces or subjects. In a first embodiment, acoustic energy contributed by one or more emitted streams is summed for cooperative treatment at a common workpiece region or site. In a second embodiment, one or more impinging streams are shaped such that they provide an acoustic amplification effect. Both embodiments may utilize beneficial agents added to the flowed impinging medium to enable or improve the treatment or cleaning process.

### CROSS-REFERENCE TO RELATED APPLICATIONS

The present application claims priority from provisional application Ser. No. 60/786,861, filed Mar. 28, 2006. The present application is also a continuation-in-part of application Ser. No. 11/193,958, filed on Jul. 28, 2005, entitled “Apparatus and Method for Delivering Acoustic Energy Through a Liquid Stream to a Target Object for Disruptive Surface Cleaning or Treating Effects”, filed in the names of the present Applicants (“prior application”). That application, which is incorporated herein by reference, claims priority based on provisional application Ser. No. 60/592,593, filed Jul. 30, 2004.

### BACKGROUND OF THE INVENTION

1. Field of the Invention

The present invention relates to devices, systems, and processes using acoustic energy for cleaning or surface-alteration.

2. Description of Related Art

By far the most widely used systems utilizing acoustic energy for cleaning are immersion systems employing ultrasonic transducers. Items to be cleaned are immersed in a liquid filled tank, usually with a cleaning enhancing agent such as a solvent, detergent, wetting-agent or cavitation-agent added, and ultrasonic energy is transmitted into the liquid tank from at least one transducer mounted thereon. There are numerous commercially available systems that utilize this technology including ones made by Branson, Crest and many others. Typically, these systems operate in the 15-70 KiloHertz (KHz) range and most commonly in the 15-30 KHz frequency range at sufficient power to drive steady cavitation, which is known to serve as the primary energetic cleaning (or treating) mechanism. Such systems and their ultrasonic output are never used on human skin, as any such significant cavitation would cause skin damage of a mechanical and thermal nature as well as pain. On the other hand, such systems are frequently used on non-living inanimate mechanical, electronic and optical parts, components, materials etc., which are insensitive to limited or even unlimited cavitation. The point is that cavitation is the primary industrial acoustical cleaning or treating mechanism for inanimate surfaces, but it is not regarded as safe for human skin use as reflected by federal regulations of the Food And Drug Administration (FDA) in the United States. The skin is a very sensitive organ and is easily damaged by cavitation phenomenon even on its surface.

Another type of system using acoustic energy for cleaning excites a tip of a tool with sonic energy and the vibrating mechanical tip is placed in direct physical contact with the item to be cleaned. An example is tooth-cleaning devices that involve ultrasonic excitation of a tooth-contacting water-flushed tip. These are the ultrasonic descaling devices utilized by a dentist for cleaning teeth. They primarily cavitate plaque and other hard tooth coatings and are not aimed at gum tissues, which are very sensitive.

Hydraulically pressure-pulsed products with pulsatile water flow, such as tooth and gum cleaners found in many modern home bathrooms, are not sonic cleaning devices; they are pulsating flow devices wherein the flow velocity equals the pulse velocity. There is no significant acoustical energy delivered by these devices nor is there any cavitation occurring.

EP 00645987B1 to Harrel discloses a descaler utilizing an ultrasonically excited scraper tip and a liquid flush. EP 00649292B1 to Bock discloses an ultrasonically energized brush used in the direct contact mode. Both of these use the acoustics to attack tooth coatings and plaques. The scraper surely cavitates and the brush might cavitate under some conditions. Again, any significant cavitation-exposure of the gums would both be painful and damaging. Note that in the above devices, the acoustic cavitation, if any, is produced directly on or at the enamel tooth surface to be cleaned by a mechanical exciter physically deliverable to that surface.

We have cited these ultrasonic references first as they are cleaning references and cleaning is a major use for our invention herein. However, as will be seen, we deliver disruptive cleaning energy in a different manner.

There are systems which (transmit/receive or pulse/echo) couple very low bidirectional acoustic energy through a short liquid stream or film to an object for non-destructive testing (NDT), but these are very low-power mapping or imaging systems in which disrupting or cavitating the object to which the liquid stream is coupled is to be absolutely entirely avoided. Such NDT systems have been known for 30 years or more. These systems use sonic echoes to analyze the object and take great pains in their design and operation to avoid any disruptive action at all. They are not cleaning systems and in fact are used to detect rather than remove contaminants. An example of an acoustic NDT system that contemplates delivery of acoustic energy to a test site via a liquid stream is found in U.S. Pat. No. 4,507,969 to Djordjevic. Note that cavitation phenomenon, if allowed, would not only damage the workpiece but also introduce un-wanted acoustic harmonics into the received echo signals. NDT imaging is therefore done at acoustic power levels far lower than that required to cavitate. Generally, such NDT systems use as short a coupling water plume as possible, as every surface ripple and bubble in the plume introduces acoustic confounding noise to the NDT process. Typically, such gravity-fed plumes are a fraction of an inch to a couple of inches long maximum and utilize essentially pure water to minimize attenuation and bubble content. Pressurized water is not used, as the flow rate needs to only be high enough to assure coupling and it is normally desired that the coupling water be conserved and not have to be cleaned up.

There is also a system disclosed in U.S. Pat. No. 5,013,241 to Von Gutfield, which claims to utilize an ultrasonically energized liquid stream to clean a tooth upon which the stream was blindly directed by a user. This device was neither clinically nor commercially successful because the design of the device ignored prior art that teaches that powers of even a few watts/cm² cause severe pain and undesirable sensations (as well as cellular damage) to the sensitive gums in real human applications. No cleaning agents were disclosed by Von Gutfield as being necessary or desirable for adding to the liquid stream. Also, the Von Gutfield ultrasonic transducer was not liquid cooled nor air-backed, thus limiting the power level and efficiency at which it could operate. The Von Gutfield disclosure did not teach the use of high power ultrasonic energy and in fact tried to keep the energy low enough to avoid admitted discomfort, which also meant that the cleaning action was rendered relatively ineffective. Had Von Gutfield used high power in the range contemplated by the device disclosed and claimed in the instant application, Von Gutfield's transducer would have overheated and failed, as well as caused severe disabling pain and serious gum damage to the patient due to cavitation. The Von Gutfield device cannot merely be scaled up or used in multiple numbers to anticipate the device disclosed and claimed in the instant application. It would not produce the result that the instant invention accomplishes, which is the rapid cleaning of objects over a relatively large area of their surface (or subsurface, interstices etc if permeable). The instant invention most preferably accomplishes this result by using an elongated energy generator that couples high-powered acoustic energy into a liquid stream(s) that is(are) directable onto an object to be cleaned. Liquid cooling of the acoustic energy source and the use of additive cleaning-enhancing or other surface-alteration agents are desirable for high efficiency operation and are not disclosed by Von Gutfield. Furthermore, multi-step processes such as cleaning and rinsing are also not therein disclosed or suggested. Immersion systems do not use flowing-liquid transducer cooling and none have contemplated their use in connection with a liquid stream that is delivering substantial acoustic cleaning energy to a distant non-immersed object. Immersion systems are effective for cleaning items that can be put into their tanks, but impractical for on-site field cleaning of large objects that cannot be easily moved into or even fit into a tank. The Von Gutfield device was designed for spot cleaning of live teeth in situ and cannot deliver sufficient power or a large enough acoustically energized liquid stream for effective use in industrial-type cleaning. The very fact that no commercial versions of the Von Gutfield invention have ever been made, despite its desirability, argues against its obviousness. There is no limit to the size of an object that can be cleaned by the instant invention, yet the prior art deals with large objects by making larger and larger immersion tanks. Pressure washers of the type that typically use piston or diaphragm pumps to deliver water blast cleaning through a nozzle at pressures upwards of 1000 psi are useful, but not nearly as effective as the instant invention, which can actually clean any portion of an object that the acoustically energized liquid can contact, including backsides, interstices, and other areas that are treated far less effectively by mere pressure blasts directed from a distal point. High-pressure jet washers do not utilize ultrasonics and thus are still subject to fluid boundary-thickness effects.

Additional patent references are included below. These provide detailed disclosures as to how ultrasound or ultrasonically produced bubbles or added bubbles can be used to enhance the cleaning of objects in cavitation-based ultrasonic immersion tanks.

U.S. Pat. No. 5,156,687 to Ushio teaches ultrasonic wet-surface pretreatments for the painting of polymers. U.S. Pat. No. 5,143,750 to Yamagata teaches oxidation removal and polishing of work surfaces using ultrasonic wet processes. EP 01036889A1 to Shinbara teaches bubble-loading of liquids to enhance cleaning in the presence of ultrasonics. None of these teaches or suggests water-jet or plume delivered high-energy ultrasound for cleaning or treating.

Finally, we have a class of devices in the prior art designed to deliver medical therapies to subdermal tissues or organs in living beings. The authors have developed products in this arena of therapeutic or surgical ultrasound. Frequently seen such applications include the noninvasive and invasive acousto-thermal ablation of cancerous tissues. If cavitation is also or instead employed, it is because mechanical tissue destruction is desired. Such destruction, given the presence of cavitation, is un-avoidable both on the macroscopic scale and on the microscopic cellular or genetic scale. So we again emphasize that the delivery of cavitation ultrasound to surface or at-depth tissues is not practiced if one desires to avoid tissue damage.

U.S. Pat. No. 6,450,979 B1 to Miwa teaches the ultrasonic exposure of subdermal fat cells in a human body for the purpose of depletion of their adipocytes fat-content. Note how carefully Miwa focuses, properly so, on avoiding cavitation in the patient. Note also how carefully Miwa avoids any significant heating (by any mechanism) of the patient's tissues. The point to be taken here is that Miwa's treatment, in industrial terms, is a very-low power ultrasound treatment as well as a non-cavitation treatment unlike virtually all industrial treatments and is not useful as an industrial treatment.

Thus, when Miwa suggests passing his therapeutic ultrasonic energy through a water stream or array of water jets (FIG. 8, for example) along the lines of the already-mentioned prior art above, it is low power non-cavitating ultrasonic energy far below the cavitation (and heating) thresholds he explicitly defines. The passage of such low power or non-cavitating ultrasound through a water stream is not at all new and has been practiced for decades in the use of water-plume coupled NDT (non-destructive testing) transducers as mentioned above. The Miwa patent claims the implementation of the acoustic obesity treatment in certain frequency and acoustic-power ranges, which have patient-acceptable hemolysis limits, cavitation limits and thermal-index limits. Industrial ultrasonic cavitation processes are purposely arranged to operate under conditions that violate some or all of these three limiting Miwa operational conditions or no useful cavitation-induced cleaning or treatment would occur in the immersion tank. Thus, the Miwa work would lead one away from the instant invention.

Further, we note explicitly in Miwa's apparatus, such as that in FIG. 8, that he has not accounted for the fact that a transducer emitting ultrasonic energy toward an aperture plate (his FIG. 8, items 5 and aperture plate with holes 31) will cause large acoustic reflections and diffractions as the leftward moving acoustic waves impinge upon his aperture plate between holes 31 and around holes 31. This results in acoustic interference, acoustic misdirection, and large acoustic non-uniformities in acoustics emanating from some or all of the orifices. What is needed, and not taught, is a means to assure that any ultrasound not emanating from an orifice 31 such as that impinging between the holes 31, does not cause a problem. Further, assuming one did crank up the acoustic power of the Miwa showerhead, one would also get acoustic cavitation inside the showerhead and behind the orifices, a location that would allow for transducer damage as well as orifice erosion. Thus, the Miwa hardware is incapable of delivering cavitating acoustic power to a distal workpiece at the other end of a water or liquid plume.

So the prior art fails to teach a means to deliver high-power acoustical cleaning or treating energy through a liquid stream in a manner wherein: a) the transducer is not thermally damaged, b) wherein interfering reflections do not degrade the passing acoustical energy, c) wherein cavitation in the streaming device does not damage the streaming device and its orifice(s), d) wherein acoustical cavitation can be driven at a distal location along the stream (if it is desired), or e) wherein cavitation, treatment or cleaning agents are delivered into or to the stream. Further, none of the prior art teaches the use of f) acoustical echoes passed along such a stream to monitor or assess a parameter such as attenuation, detergent-content or a workpiece-distance for such a cleaning or treating process. Finally, none of the prior art teaches g) the manipulation of the shape of the stream(s) or jet(s) to enhance acoustical waveguiding or acoustical amplification phenomenon such that distal cavitation can be accomplished.

The instant invention preferably utilizes extended streams or plumes (fractions of a meter or at least several centimeters long), laterally-extended plumes or films of liquid or utilizes arrays of smaller streams with overlapping treating action that have not been suggested by the above art and that would cause severe multi-path signal propagation problems for the prior NDT art. The prior art low-flow approach would not allow for a meter-length plume to be formed at any significant angle to gravity or the vertical using water. We also have discovered that separate adjacent impacting plumes or streams can provide a work surface interstream cleaning effect due to acoustic propagation laterally on the work surface within the liquid meniscus between impinging streams, something not disclosed or suggested by the prior art. Our optional use of bubbling or bubble constituents in a flowing jet of liquid intended to deliver acoustic energy to a workpiece is counter-intuitive. We find that low to moderate amounts of bubble volumetric percentage makeup in the plume add more stable and/or transient cavitation acoustics action than they cost in terms of increased attenuation. At some point a high enough (suds-like) concentration of bubbles will deliver virtually no acoustic cleaning action. Thus, there is a workable middle ground. Furthermore, even non-bubbling additives increase attenuation, but we again realize that the added detergent effects outweigh the attenuation effects at least for low to moderate concentrations. These are counter-intuitive improvements from purely the acoustics-manipulation point of view.

Because we can operate at moderate to high power (because of our unique preferred transducer liquid cooling and efficiency-enhancing air-backing and matching layer(s) of our transducers) and we can also optionally get additional beneficial stable and/or transient cavitation effects from modest levels of bubbles, we can afford to lose some acoustic energy to attenuation and scattering losses in the plume. So we can tolerate a variable-shaped plume and even plumes containing surface-ripples, defects and turbulence, if necessary. The toleration of turbulence or undulating surface shapes in a liquid waveguide is totally contrary to all the prior art. In NDT it introduces chaotic signal noise thus very, very low flow, low velocity laminar streams are utilized in NDT. In dental applications, it would involve very high flows introducing further considerable uncomfortable sensations and mouth flooding even with oral aspiration. In general, we utilize a somewhat acoustically lossy flowing liquid waveguide contrary to all prior NDT and dental teaching. Uniquely, our plume waveguide can flow quickly if desired, such as to direct it sideways or to provide impacting water pressure at the impact zone.

Thus, a need exists for a system and method for an acoustically enhanced liquid cleaning or treating approach that does not depend upon immersion of the object to be cleaned and can utilize multi-component liquids, workpiece-cavitation as desired, and medium to high-power without transducer overheating, internal cavitation or damaging internal reflections. There is also a need for a system that can effectively clean in shielded or obstructed areas where the cleaning effect of high velocity liquid blasts is decreased. It is also desirable that such a system be capable of being used in hand held or fixed mount devices and which also can be automatically or manually directed towards objects to be cleaned.

### BRIEF SUMMARY OF THE INVENTION

The present invention combines a liquid cooled, preferably elongated, acoustic energy source capable of moderate to high power operation, a liquid stream(s) into which acoustic energy is coupled with the stream(s) being directable onto and or into a target object for delivering acoustic cleaning energy and associated liquids thereto. The acoustic energy source is preferably air-backed and acoustically impedance matched with a matching layer, such that the treating or cleaning acoustic energy is efficiently propagated forward toward the workpiece. Some cooling is provided for the transducer at least by passing plume liquid and possibly also or instead by additional conductive or convective measures as is convenient.

In one embodiment of the invention, an apparatus for treating or cleaning a workpiece is provided that utilizes acoustic energy carried to the workpiece through at least one flowable stream directed at or upon said workpiece. The apparatus comprises
a flowable medium that can be flowed as at least one stream or plume at or upon the workpiece from a flowable medium flow-emitter or orifice;
a source of ultrasonic, acoustic or vibratory energy acoustically coupled into at least one such stream or plume at one or more points in a manner allowing at least part of the coupled acoustic energy to propagate to the workpiece through at least part of one such stream or plume;
the workpiece or treatment object situated, for at least a period, in the range of at least one such stream or plume, allowing for impact of the plume carrying at least some the acoustic energy upon the workpiece;
the impinging stream(s) or plume(s) carrying the ultrasonic energy during at least a portion of an impingement period;
the workpiece impingement angle or angles having at least one value between 0 and 180 degrees; and
the angle of the plume or average plume-angle at at least one position on the plume being between 0 degrees and 180 degrees to local gravity, whether that angle to gravity is natural or artificially induced.

In another embodiment of the invention, an apparatus for treating or cleaning a workpiece or object is provided that utilizes acoustic energy carried to the workpiece through two or more flowable streams or plumes substantially commonly directed at or upon a workpiece or site thereon for at least a period. The apparatus comprises
a flowable medium that can be flowed at or upon the workpiece from or out of two or more plume or stream orifices, flow-apertures or flow-sources;
at least one source of ultrasonic, acoustic or vibratory energy acoustically for coupling into two or more such streams or plumes at one or more points on each such stream or plume in a manner allowing at least part of the coupled acoustic energy to propagate to the workpiece through its respective stream or plume or through two or more plumes;
the workpiece or treatment object situated, for at least a period of time, in the range of the commonly directed streams or plumes, allowing for impact of the collective stream or plume while carrying their collective acoustic energy upon the workpiece; and
the workpiece thereby being cleaned or treated by two or more co-directed plumes or streams, two or more of which carry co-directed ultrasonic energy which is phased in time by any means to be constructively interfering or additive at least for useful treatment periods.

### BRIEF DESCRIPTION OF THE DRAWINGS

FIG. 1 shows a system of the present invention delivering acoustic energy to an object to be cleaned through a liquid stream in accordance with an embodiment of the present invention.

FIG. 2 shows an alternative embodiment of the system of the present invention in which discrete acoustically energized liquid streams are directed onto an object to be cleaned.

FIGS. 3A-3C illustrate further alternative embodiments of the invention that depict inventive systems utilizing apertures or orifices in front of one or more transducers, the apertures or orifices providing one or both of flow shaping or acoustic beam shaping.

### DETAILED DESCRIPTION OF THE INVENTION

I. Definitions.

The following definitions are put forward not as an exhaustive all-inclusive interpretation of words used, but as an aid in understanding the words as used herein.

Liquid: Any flowable material or media that can be poured, expelled or otherwise extracted under a pressure gradient, gravity, by surface-tension, capillary-action or acoustic-streaming pressures. A liquid may contain any or all of additional additive or materials such as detergents, bubbles, abrasives, ice, etc. The liquid may also contain solids in other physical-phase forms of itself (ice particles, steam, vapor bubbles). The liquid may have any number of phases and may comprise a solution, mixture, emulsion, paste, cream, gel, foam, suspension, etc. Typically, at least one treatment substep will involve an additive or agent being placed into or used with the liquid, such as a detergent or wax.

Plume, film or stream: A volume of liquid that is substantially transportable to a workpiece from an emission orifice(s). May be continuous at a given moment (connecting the orifice and workpiece) or discontinuous at a given moment (disconnected from one or both of the orifice or workpiece at a given moment). Typically, flowed by gravity and/or pressure but in some cases flowable using acoustic-streaming or capillary-action surface-tension forces.

Acoustics: Acoustic, sonic or vibratory energy which is injected, coupled into or produced within an emitted liquid plume, film or stream in any manner, at least some of which arrives at the workpiece before total attenuation occurs. Frequencies will typically be chosen in the range from 1 KHz to tens of MHz. Energy may be single frequency, multi-frequency, variable frequency, alternating frequency, broadband frequency, CW, pulsed, chirped, etc.

Bubble: Any stable or transient void or vapor bubble in a liquid, regardless of how it was formed or when it was formed. Stable oscillating bubbles can be driven with low acoustic power, whereas transient bubbles require high acoustic power. Bubbles may be in the stream and/or in the wetted or impacted film upon the work surface. Preformed bubbles may be injected or solid or gaseous nuclei typically smaller than the in-situ seeded bubbles may be employed. Also, included in the definition of bubble is any particulate which itself contains a gas or air.

Transducer: Any device that can convert a first energy type into acoustic, sonic or vibrational energy. Typically, the first energy type is electrical, electromagnetic or electrostatic energy. Transducers may be of any type including single-element, multielement, arrays, mechanically focused, acoustically lensed, mechanically unfocused, mechanically collimated, mechanically defocused, mechanically scanned, electronically scanned, etc. Multiple different transducers may be used in one or more plumes or films or two or more transducers may simultaneously be operated with different acoustic parameters.

Multi-step process: Any workpiece cleaning or treatment process wherein at least one operative parameter or constituent is changed during the total overall process-even if it is merely altered between on and off or between two fixed values. The parameter may be a liquid flow, an additive concentration, a plume shape-change (e.g., film to spray), an acoustic power, a temperature, a flow rate, etc. A typical multi-step process would be an acoustic clean followed by a rinse.

Attenuation: A measure of the time it takes for acoustic waves to decay from 90% of their initial value to 10% of their initial value. Typically, with a few exceptions, attenuation rates rise with frequency and the addition of additives including bubbles.

Water: Typically, untreated faucet or well water, treated or softened municipal water, or filtered water of any type. May be provided from domestic or industrial plumbing, from a user-reservoir or tank, from a hose, from a tanker-truck or a deionized water system. Water particularly for cleaning is beneficially treated to remove potential residues such as carbonates or particulates.

Disruptive: Altering or changing a property of an object or its surface. Used to distinguish the aggressive cleaning action of our acoustically energized liquid streams from the deliberately delicate non-disruptive acoustically energized liquids streams of the NDT prior art. We note that disruption may take place on the surface of the workpiece most commonly, but we also anticipate the ingress into the workpiece of some liquid, additive, and acoustical energy such that sub-surface regions may also be disrupted or altered. A good example of this would be the inventive disruption of a permeable material for at least several cell-dimensions distance below the exposed surface.

Target surface: The site to which the acoustically energized liquid or flowable stream is directed. The surface can include materials that are impermeable, permeable, or any combination of properties that affect the interaction of the liquid and the object that it impacts. The target surface may be below, adjacent beside or even above the device. In many applications, such as cleaning or treating permeable fabric from roll-to-roll, the wetting and cleaning action will take place through the entire fabric thickness-perhaps with some or all used liquid leaking through the fabric-despite the cleaning wand being on just one side of the fabric web.

While operating in the cavitational mode, the invention may be used, for example, for wound-cleaning or debridement. In this special human or animal case, surface-damage is actually desired to remove scab and other undesired tissue and exudates.

Further, while operating in either the cavitational or non-cavitational modes, one may utilize the apparatus to enhance the permeability of the skin or to treat burns, for example.

Both of these examples are of surface-driven processes not taught by the prior art using our type of apparatus and method.

II. Acoustic Cleaning System.

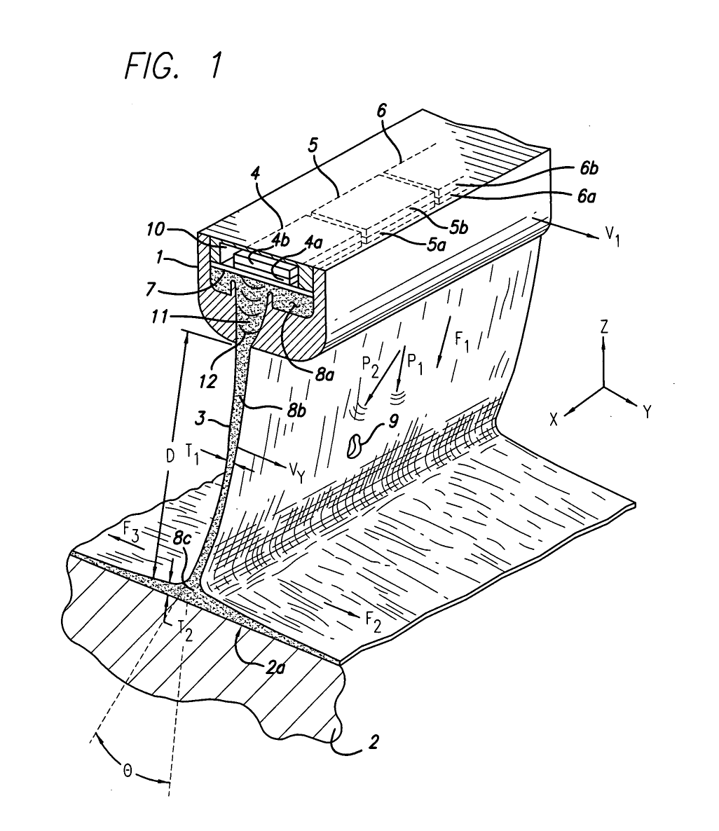

FIG. 1 shows in cross section an embodiment of an acoustic cleaning system. A cleaning wand 1, which may be manually directed or directed through any number of mechanical, hydraulic, pneumatic, electromechanical or other steering or manipulating means, is shown as being elongated or extended in the X-axis. The wand includes an elongated row of ultrasonic transducers of which the first transducer in the row is shown as 4 with its respective piezoelectric element 4b, which produces acoustic energy when electrically excited. Transducers may be of any type including piezoceramic, electrostrictive, magnetostrictive, electromagnetic, ferroelectric, electrostatic or MEMs-based such as CMUTs (capacitive micromechanical ultrasonic transducers), photoacoustic or any other known transducer types. The transducer(s) is(are) preferably air-backed and, at least partly, liquid cooled by the passing plume liquid. Item 4a is an acoustic matching layer for transducer piezomaterial 4b of transducer 4 and serves to optimize the acoustic coupling of acoustic energy from the transducer piezomaterial 4b to the liquid 8a/8b, which is on the other side of the liquid-isolation membrane 7 which serves to isolate the transducers 4, 5, 6 from the liquid 8a and any associated additives or agents therein. The liquid 8a preferably flows along a distribution manifold (shown generally running along the ±X-axis) and exits as a liquid 8b forming a film-sheet or stream 3 as it exits from the orifice 11. Orifice 11 is showed as tapered in shape, which has the effect of amplifying the acoustic pressure waves P₁ that propagate generally downwards (-Z-axis) towards a work substrate 2 with a dirty surface 2a. Explicitly noted at this point is that our acoustic energy directed into the plume may be in the form of blanket energy or focused energy, and the focus may even be moved within the confines of the plume as by operating the transducers 4, 5, 6, etc. as a phased array and steering in a direction such as the ±X directions. This also allows for exceeding the cavitation threshold outside the head 1 as the individual transducers 4, 5, and 6 beams may be energetically added as by overlapping them at the workpiece. Our orifice 11 may be in the form of a single continuous straight or tapered slit (shown in FIG. 1) or in the form of juxtaposed but separate slits or holes (not shown in FIG. 1). One or more rows of slots or holes or a random array of slots or holes 11 may alternatively be utilized. In the case of separate slits or holes, we can optionally arrange for the individual fluid jets or plumes to combine soon after exit to form a continuous plume (if desired). Within the scope of our invention is any orifice or aperture 11 shape or pattern including the orifice 11 comprising a porous material or an array of size-adjustable apertures. We note that appropriate acoustic antireflection measures may be taken in the manifold and behind-orifice regions to avoid undesired multiple reflections or diffractions. Such measures could include, for example, the disposition of acoustical lossy absorbing films (not shown), or the disposition of highly scattering surfaces (not shown) or the focusing or directivity of the transducer(s) 4a/4b mainly (shown) directed only into the plume(s) 3.

Pressure waves P₁ (vertically directed) and/or P₂ (angularly directed) from the transducers are coupled into the liquid plume 3 through acoustically-transparent membrane 7. Membrane 7 could, for example, be a very thin stainless steel foil or a copper-foil that would have acceptably low acoustic losses, a hermetic nature, and serve as an electrical ground electrode if desired. Transducers 5 and 6 are the second and third transducers (with piezo electric elements 5b and 6b respectively) in the extended row and are coupled to the liquid through their respective matching layers 5a and 6a and membrane 7. The acoustics oriented reader will realize that the membrane may also be sandwiched between the matching layers and PZT exciters (arrangement not shown) or one may even utilize the membrane material itself as a matching layer. Further, one may sacrifice coupling efficiency and omit the matching layer. Item 8c is the deformed liquid stream 3 as it impacts the surface 2a to be cleaned or otherwise treated or altered. Item 9 illustrates a transient defect (hole) in the otherwise substantially continuous film or stream 3. Transient defects such as hole 9 do not substantially impact the effectiveness of the cleaning as the acoustic energy from at least one transducer will propagate around the defect and the acoustic shadow of the defect will likely move in the X-axis as well. In fact, the present inventors include an embodiment wherein controlled bubbles or microbubbles are purposefully formed in or injected into the plume to serve as cavitation sites. In some cases, injected additives or agents, even of a solid nature, may serve as cavitation nuclei. An air cavity or “air-backing” 10 is shown surrounding the backs of transducers 4, 5, and 6 in the array. The use of air on the backside of the transducers minimizes backwards acoustic propagation, thus enhancing the acoustic efficiency of selectively delivering acoustic energy in the forward direction of the liquid. However, this makes liquid cooling of the transducer using the plume liquid highly desirable. The acoustic pressure waves formed by the interaction of the transducers and the liquid that flows past them produces pressure waves 12 shown in vector-format as P₁ and P₂ in the film 3. F₁ is the liquid flow vector in the downwards-moving film of liquid 3. F₂ and F₃ illustrate the split lateral flow vectors of F₁, after it impacts the surface 2a and is typically redirected. P₂ illustrates pressure waves angled sideways in the X- and Z-plane as by phase-delayed firing of two transducers 5 and 6 (beam-forming) or as by angled propagation from a single transducer 4, 5 or 6. V₁ is the translational velocity (if any) of the wand 1 in the Y-axis and V_{Y} is the velocity of the film 3 in the Y-axis. At a given instant, these may have somewhat different values. T₁, is a local thickness of free film 3. T₂ is a local thickness of the film on surface 2a near the point of impact. D is the approximate film length or working-distance in the Z-axis and we specifically note that because the film 3 curves to an angle theta (θ), that the actual curved film 3 length is somewhat longer than D. Theta is the angle of film impact (shown to be about 20 to 30 degrees in FIG. 1. The plane of the film 3 is shown generally to be in the X-Z plane with the wand velocity V₁ generally in the Y-direction (mutually orthogonal). In the most general case, V₁ and/or V_{Y} may have an angle to the film plane and the wand may also have rotational or twisting components as well as D, T₁, T₂ and theta, F₁, P₁ and P₂ variations as it is used. Acoustic waves emanating generally downwards through film 3 of average thickness T₁ will undergo reflection, refraction and mode conversion upon impacting the surface 2a and/or upon interacting with turbulence, ripples, bubbles or shape-variations in the surface (or volume) of film 3 (such variations not shown). At any instant, V₁ may be different from V_{Y} due to wand or plume accelerations and twisting. The shown curved shape of film 3 is due to wand movement V₁ and/or gravity and would likely be vertically oriented and straight if emitted from a static wand directed downwards or in the −Z direction. The wand 1 can be manually moved or moved by any convenient means. It may even be used as a subsystem component in a larger machine such as in a car-wash. In yet another possibility the plume by itself might be scanned as by manipulating fluid pressures or orifice shapes/directions (not shown). Alternatively, or in addition, the work article 2 may be moved. In simple form, the wand 1 can have a number of ultrasonic transducers such as 4, 5, 6 . . . (three such transducers are shown), which are fired individually, one at a time, or in pairs or other multiples, and whose firing can be “walked” up and down the row. In more sophisticated versions, they could be operated as a phase-gated array for the purpose of electronic beam steering within the confines of one or more plumes. They may also be all fired simultaneously, whether or not they are steered into each other as by electronic beam forming. Also, by moving the plume itself, as by scanning it, it will effectively move the entrapped acoustic energy with it. The acoustician will realize that acoustic beam-forming and aperture-control schemes typically applied to medical ultrasound imaging or sonar could be utilized here. The heating of the liquid, which can be provided by the transducers' waste heat, is likely to be slight, typically a few degrees C or less. If a high temperature liquid is desired for enhanced cleaning or treating, then true liquid heaters can be added to the system. Such heaters, pumps, etc. could be located in the wand itself, or more preferably located in a supportive control or utility box (not shown) which can lay on the ground, be mounted in a backpack, or at least not have to be hand-held.

Typically used liquid additives (agents) would include items such as detergents, soaps, emulsifiers, solvents, surfactants, antimicrobials, sterilants, biocides, wetting agents, surface-tension adjusters, pH adjusters, bubbles or bubbling particulates as cavitation agents, etchants, passivations or other workpiece coatings. They could also include insecticides, antifungicides, antibacterials, antivirals, oxidizers such as hydrogen peroxide, antiseptics, chemical etchants, primers, paints, polishes, waxes, ultraviolet barriers, sealants, stains, other decorative finishes or even abrasives. Additives may act on their own or may react with other additives or with the workpiece surface being treated. Most implementations will utilize a carrier liquid such as water or a solvent (possibly with additive(s) in it), but the invention may alternatively utilize a material or media possibly defined above as an “additive” alone instead. Water will be the typical plume liquid utilized and that water may be preconditioned as by heating, cooling, additive mixing, degassing, gasifying, water-softening, filtering or pH adjustment. The plume liquid(s) or additives may also be recirculated or refiltered in any convenient manner. Additives can be introduced directly into the acoustically energized liquid film 3 at any number of points before impact or in an alternative approach they could be delivered to the surface 2a from a different source or delivered separately to mix with the acoustically energized liquid. We note that in some applications water may not be used and instead a solvent, for example, is used. Alternatively, the wand 1 may emit nothing but the “additive” or agent with no dilution or buffering. We simply note that water is expected to be a common base-liquid or sole emitted liquid, as it is inexpensive and readily available and, if desired, can easily be filtered and recirculated.

By delivering the acoustically energized liquid in discrete and physically separated volumes or packets (not shown) further enhanced cleaning action and/or conservation of dispensed liquids or additives may be obtained. Even though the packets or stream-segments are not directly coupled to the transducers, once they leave or detach from the orifice 11 (they become non-bridging and separated, at least temporarily), they still contain internally propagating and reflecting acoustic pressure waves which, if they reach the surface 2a before their energy has decayed or attenuated too far, can still deliver enough energy to the surface to perform a useful cleaning (or treating) action. Since acoustical energy dissipates quickly, this approach may require a very high velocity water plume and a shorter working distance D. In cleaning of contamination that has resilient components, sometimes a period of time without liquid impact will allow a spring-back action to occur, which will place certain previously bent-over contaminants in a better position or attitude for cleaning by the impact of a subsequently delivered acoustically energized liquid globule or “packet”. Furthermore, the impact of each separate stream-segment, packet or globule involves more disruptive energy than an equivalent unbroken single segment. Pulsatile continuous flow (pressure-varying wherein the pressure waves travel approximately at the stream velocity) may be even better for this situation, since it permits a direct coupling of the transducers to the liquid during the entire transit from the orifice 11 to the surface 2a and even beyond that point. It is a simple matter to produce isolated-globule or pulsatile continuous flow liquid using pumps, electrically controllable valves or many other well known techniques.

The device of the instant invention can be used in multi-step operations where wash and rinse cycles are used or an active or passive drying cycle is introduced. The liquid (and/or additives or agents if any) may be filtered and or recirculated and can be alternately applied to the surface 2a with and without acoustic energy coupled into it. They might also be delivered into the plume 3 or onto the workpiece 2, as by deposition from an ambient surrounding the plume 3. The width-taper of orifice 11 causes an amplification effect that is sometimes beneficial but is not essential to the operation of the device. We note further in FIG. 1 that the plume or stream 3 is itself tapered to be narrower at the workpiece 2 than at the wand 1 such that acoustic amplification will take place in the stream in the known geometry-derived manner of tapered acoustic horns. Such tapering or other beneficial shape control of the plume(s) may be implemented in any manner including via: a) known surface tension effects, b) passage of the plume through a surrounding or ambient static or flowing gas or in proximity to a flowing gas jet or duct, c) electrostatic effects when using a conductive or charged liquid, d) magnetic effects when using a magnetized liquid, e) thermal gradients affecting surface tensions, f) thermal gradients affecting viscosity, g) temporary thickening of the plume locally at the exit orifice as by, for example, spinning of the orifice head, h) drag effects, i) the effect of acoustics being pumped into the plume or j) an effect of additives or bubbles.

Multi-step cleaning or treating processes are contemplated herein such as:
a) clean and rinse, optionally dry;
b) clean, rinse, optionally dry and apply seal (coating);
c) cavitationally abrade and rinse, optionally dry;
d) cavitationally abrade, rinse, optionally dry and apply seal (coating);
e) etch (chemically/acoustically), rinse, dry and prime (coat);
f) etch (chemically/acoustically), rinse, dry, prime (coat) and paint (coat) or just etch/paint;
g) etch, rinse, dry, prime (drying using flowed gas, for example, or a water dissolving solvent);
h) cavitationally abrade and rinse (without grit, replace sand-blasting, for example);
i) wash and optionally polish (autos, trucks, trains, planes)
j) degrease and rinse, optionally dry; and
k) strip paint, wash, rinse and optionally dry.

Operation of the device of the present invention is relatively straight forward. The transducer(s) excitation mode is preferably CW (continuous wave) or CW pulsed and can employ swept frequencies or multiple or single discrete frequencies and/or harmonics as is known in the acoustic arts. We can emit single or multiple different frequencies or even broadband spectrums from a given transducer or from neighboring transducers, and these frequencies can be mixed and even beam-formed using phased array techniques known to the acoustic arts. One may also or instead use wave-shaping or wave-biasing in known art manners to suppress or enhance cavitation (acoustical formation of bubbles) if that is desired. We utilize, optionally, one or both of stable cavitation and transient cavitation, the two known types, wherein we enhance cavitation for some processes. Stable cavitation typically involves bubbles that oscillate between finite non-zero sizes. Such oscillation requires little acoustic energy, given a seed-bubble is provided in the form of a microbubble or dissolved gas that precipitates out of solution. Transient cavitation involves total cyclic collapse of the bubble and is a process requiring large acoustic input energy as the bubble is ripped from solid fluid every wave-cycle. Such cavitation can also cause physical erosion or pitting or the workpiece if desired. Transient bubbles require no seeding at all, although surface-tension reducing agents, dissolved gases, and injected microbubbles, for example, enhance the known effect. However, such transient cavitation is energy-consuming and can be damaging to a workpiece or painful to a human subject. On the other hand, desirable surface-altering processes are frequently means of controlled uniform damage such as grit-blasting, paint-stripping and sanding. Thus, such surface damage may be part of a useful surface-process such as abrasion or physiochemical etching. When stable or transient cavitation occurs, some bubbles are acoustically excited into oscillation wherein microstreaming flow occurs around the bubble periphery, thus enhancing the cleaning action of the liquid stream particularly adjacent the work surfaces where such bubbles tend to loiter and energetically collapse. Again, these are acoustically-known cavitation effects. Within the scope of the invention is certainly the formation and/or delivery of cavitation bubbles to the workpiece to enhance our inventive cleaning and treating processes. However, we further include in that scope that such cavitation bubbles or nuclei therefore may be formed or injected at any point before workpiece arrival, such as in the plume or in the apparatus head itself. We anticipate that for the higher plume flow velocities that a single cavitation event will take place over a physical traveled distance in the plume and it is thus possible to have cavitation events begin in the plume before finishing (imploding) at or within useful range of the workpiece. Thus, we anticipate that, particularly for higher plume velocities, a plume cavitation event might transpire through a range of plume locations-ideally with the cavitational collapse taking place at or on the substrate surface 2a.

The operative liquid, for example water, is preferably cleansed of particulates, carbonates, solids and other filterable or easily extractable contaminants with an accompanying filter or known filtration-bed means, which may itself be disposable or cleanable. Contaminants that can be removed from the workpiece or from the plume fluid medium by chemical treatment can be treated by chemical processors that are incorporated as a part of the liquid treatment subsystem. The direction of acoustic waves, such as P₂ and P₁, may be implemented as by operating a multiplicity of transducers as a phased array (steering) or by orienting the transducers or using concave or other specially shaped transducers or other known means of focusing (mechanical focusing not depicted), steering or shaping acoustic wavefronts. Although not needed in prior art industrial cleaning ultrasonic-immersion processes, one or more transducers may be utilized herein in pulse-echo configuration to deduce parameters of interest such as dimensions (e.g. workpiece distance D) and/or workpiece shapes and/or attenuation of plume 3. PZT transducers can be used to alternately “transmit” or “listen”, as is well known. Included in the scope of our invention is the use of pulse-echo or CW-CW echo techniques, for example, wherein ultrasound passed down the beam is passed again up the beam. Also included in the scope of our invention is the passive detection of cavitation anywhere that it occurs. For a pulse-echo approach, at least some reflected acoustic energy can be sensed coming back up a continuous film or stream 3 for at least one of the purposes of: sensing the degree of film or stream continuity or attenuation, flow-velocity, additive-content, sensing of a tool to work-surface distance, sensing of a velocity of an effluent of the tool, or sensing an angle of impingement of a film or stream upon a work-surface. These functions can be performed by circuits, sensors, methods and algorithms well known in the pulse-echo acoustic art. Also included in our inventive scope is the use of prior known pitch-catch arrangements wherein the acoustic transmitter and receiver are separate.

Fluid or flowable-media (liquids, gases etc.) manifolds such as 8a may deliver water, detergents, wetting agents, surface-tension controlling agents, gas or vapor bubbles, micro bubble media, solvents, abrasive particulates, workpiece coatings or any agent that can enhance a desired surface alteration (or coating) operation such as cleaning, abrading, conversion, etching, priming, polishing or even drying. We include in the scope of the invention the practice of electrochemical conversion such as anodization wherein an electrode and current path may be utilized, perhaps using an electrolyte as the plume fluid. The operation of wand 1 may alternate between wash, rinse or dry and can optionally be arranged to deliver air, even heated air, through the orifice 11 to enhance drying. Included in the scope of the invention is the use of orifice 11 or additional coaligned or nearby orifices or nozzles to also deliver gaseous or vapor materials which do not necessarily carry acoustic energy for cleaning or treatment steps. Chunks or globules of non-bridging plume film (not shown) or isolated substreams (isolated from one or both of the wand or work surface at at least one point in time) may be used instead of a continuously bridging film as shown in FIG. 1. If liquid chunks, globules or “packets” are used, chunk transit time across gap D is set to be on the order of or less than the acoustic decay time if the chunks are to be effective as acoustic energy carriers. In other words an acoustically excited liquid chunk or globule impacts the work surface while it still has useful residual acoustic energy therein ringing about, as yet unattenuated. Plume chunks may take any shape, including, but not limited to, droplets, streams, and threads. The most desirable chunks are elongated in the flow F₁ direction as they offer more lower-frequency resonant modes having lower attenuation, thus more resonant total energy and a slower decay time. The working distance D may vary from very small (just big enough to avoid collision with workpiece 2 to quite large (on the order of fractions of a meter to meters) as long as an average low-defect path can be maintained. In general, higher viscosity and low surface tension liquids will be particularly adept at this but any liquid, such as water, will allow formation of unbroken plumes of useful utility. The liquid into which acoustic energy is coupled may be heated and/or cooled in any manner as may the workpiece itself. The liquid may be a solution, a mixture, an emulsion, a paste or cream, a gel or any other flowable material regardless of how many phases it has. We emphasize that flow may be very slow as for a viscous liquid falling primarily under the influence of gravity (e.g., mm/sec) and may be very high such as for the high pressure supersonic flow of water. At low velocities and higher viscosities, the ultrasonic energy will actually stream (pump) the flow significantly. Flowed constituents may purposely change phase or react with each other or with the workpiece 2/2a in support of a surface process performed by the wand 1. Typically, the emitted flowable media will comprise water with some consumable (or recirculated) additives. Film 3 typically impacts surface 2a at angle theta (θ) shown in FIG. 1. Angle theta will affect acoustic propagation amount and type in +Y and −Y directions. We note that appropriate angle theta impingement combined with gravity orientation, for example, could provide a wetting impacting meniscus that flows primarily or only in one direction-downwards for example (not depicted). Film 3 may have a flow velocity (parallel to flow direction F₁) as high as sonic velocity but typically a fraction of sonic velocity such as for a high-pressure ultrasound-assisted cleaning wand, or as low as required to just prevent uncontrolled breakup. By sonic velocity we are talking about sonic velocity of the ultrasound in the plume fluid. Emanated acoustics may be manipulated to acoustomechanically suppress film breakup using streaming pressures to benefit and extend working distance. A preferably wand-based trigger or switch may be used to activate acoustics and or liquid additives. As a matter of safety and for regulatory compliance, the user will be electrically isolated by known UL® approved electrical-isolation measures such as isolation transformers and known electrical-isolation double-stage protection schemes. We again note specifically that flow F₁, depending on angles of the wand and the workpiece vs. gravity, might result in a redirected workpiece surface flow of only F₂ or only F₃. This might be quite useful wherein recontamination of the workpiece is to be avoided. We have shown a typical case wherein the flow is bidirectionally split on the workpiece surface.

Film (flowable media) 3 may comprise a slurry formed of materials such as ice particles, microballoons, beads or by other particles or extended molecules. The additive or filler material might even be reusable. The wand 1 may be oscillated or stepped, rotated or twisted. The work substrate 2 may instead or also be translated/rotated. The overall dimension of wand 1 may be from micromechanical (micronsized) to meters if not tens of meters. The operative frequency may be beneficially chosen or dynamically controlled to have a controlled ratio to a dimension such as T or D and may be of the frequencies normally used in commercially available immersion ultrasound cleaning tanks. Relating an operational frequency to a dimension for acoustic propagation, resonance or amplification purposes is widely known in the acoustic art. The present Inventors expect that the inventive system will typically operate in the 10-150 Khz range for cavitating and non-cavitating applications and all the way up into the megahertz regimes or above for non-cavitating applications. Waveguides are known in the art to operate best when the propagating wavelength(s) have certain preferable known ratios to the waveguide cross-section in particular, as well as to the waveguide length. Flow F₁ is preferably at least partly laminar but turbulent flows F₁ which have low average duty-cycle (transient) propagation-path defects (e.g., defect 9) are also useable in our device because we do not care if the acoustic attributes of the shape-varying jet 3 cause some active or passive acoustic noise or transient masking. Still, on average, despite transient defects 9 and jet 3 shape-changes, we deliver high enough average acoustic power to cavitate if desired. The acoustically inclined will recognize this condition as a mechanical index or Ml=1 or above. The wand 1 performs a disruptive process upon the substrate 2 and changes the substrate in some manner as opposed to the NDT systems, which strive to avoid any disruption or change in the object to which the acoustically energized liquid is directed. The emanated liquid/mixture/solution (or constituent thereof may or may not have a constituent that remains with the substrate 2. For example, if the process is a coating process, then some part of the emanated material would either be deposited permanently or would cause a surface-altering process to take place (e.g., etching, conversion-coating, or paint-coating).

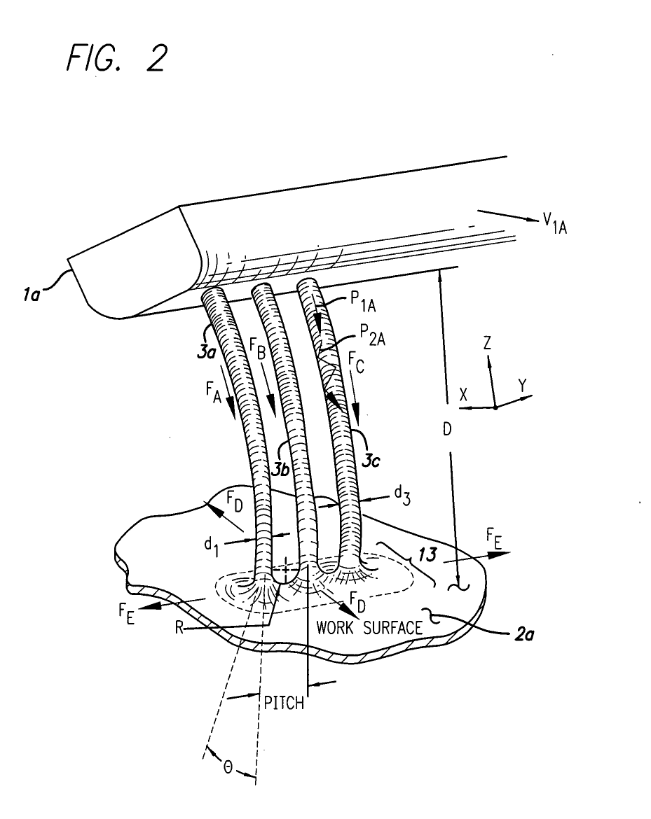

FIG. 2 shows an embodiment of the present invention that performs cleaning of a work surface 2a by deploying a multiplicity of individual separated acoustically energized liquid streams. FIG. 2 depicts the second mode of plume disclosed, namely that of a plume stream-array as opposed to the single plume film of FIG. 1. Pictured in FIG. 2 is a cleaning wand 1a having three shown circular cross-section jets ejecting or emitting upon a work surface 2a. The three jets 3a, 3b and 3c have individual flow rates F_{A}, F_{B}, and F_{c} respectively, as well as respective average diameters of d₁, d₂, and d₃. For the sake of the example, all flow rates are equal and all stream diameters are equal. In this example, we have (not shown) transducer means inside of wand 1a directing ultrasonic energy into each plume or stream 3a-3c. Such directing could be, for example, by three separate transducers or by one common elongated transducer.

It was realized by inventors that when the three streams impact in region 13 upon the surface 2a (sometimes referred to a “work surface”) that ultrasonic energy (as well as fluidic flow kinetic energy) is redirected to fill the interplume gaps shown having a wetted meniscus radius R. So we have downward flows F_{A}, F_{B}, F_{c} combining and causing work surface flows of the types F_{D} and F_{E} shown. Thereby originally downwards directed acoustic energy can be, at least in part, redirected laterally or normally into the surface 2a itself. This allows us to “alter” a surface 2a area larger and more contiguous than the isolated gapped impinging streams 3a, 3b, 3c would seem to support. Again note that each of or any of the streams 3a, 3b, 3c could be tapered to cause acoustic amplification (not shown). The invention does not require use of the shown overlapping impact meniscuses; however, they allow avoidance of untreated strips of work surface between jet-plume impact areas.

The inventors have found that as long as the pitch (spacing) of the adjacent plumes is not hugely greater than the plume diameter d₁, then effective cleaning can be achieved even between plumes due to the (overlapping) meniscus of radius R that wells around the plume impact points and the above lateral acoustic propagation in that meniscus overlap region. This welled wetted (non-zero thickness) mound or overlap region is capable of passing ultrasonic energy within itself such that all wetted regions of the work surface at least in the wetted region 13 are effectively cleaned. Within plume 3c, we further depict ultrasonic waves passing straight down the plume as P_{1A} as well as additional or alternative waves P_{2A} passing along that plume via some reflections from the plumes water/air boundary. Passing waves may or may not undergo reflection, refraction or mode changes depending on the exact plume geometries, surface shapes, ultrasonic frequencies and materials. As with the apparatus of FIG. 1, the inventors realized that acoustical energies arriving from or passing through one or more plumes of FIG. 2 can undergo modal changes such that within the wetted welled meniscus and water-mounds one has a complex combination of pressure waves, shear waves, and even waves induced in the work surface 2a/work article 2 itself. As with FIG. 1, the user of the apparatus of FIG. 2 may have different flow rates and/or acoustic energy regimens delivered through one or more plumes (streams) of FIG. 2. As with FIG. 1, we can tolerate some occasional gaps and defects in the plumes due to the above bridging effects on the work surface. As with FIG. 1, one may utilize continuous plumes (shown), transitory single-gapped plumes, or transitory double-gapped chunk or globule plumes as described for FIG. 1. We note that in this FIG. 2 case of multiple plumes, one may time-stagger such transitory gaps or chunk emissions between neighboring plumes. Inventors also note that although we have mainly described continuous wave (CW) operation of the transducers we include in the scope of our invention pulsed operation, which is particularly advantageous if broadband frequencies are to be delivered, as is known in the acoustical arts. If doing pulse-echo or pitch-cath acoustical interrogation of the plume or of the geometry, it is not a requirement that that task be performed by the treatment transducers. Separate transducers may be utilized if advantageous.

The present inventors note that it is quite easy to establish a large stand-off dimension D in FIG. 2 as compared to the film plume 3 of FIG. 1. This is because, surface tension-wise, a generally cylindrical plume 3a, 3b, 3c is less metastable than a film plume 3 of FIG. 1. The inventors include in the scope of the invention embodiments wherein the plume arrangement combines the films and streams of FIGS. 1 and 2 or the plumes temporally or spatially alternate shapes or dimensions.

Referring again to FIG. 2, we note that we could have alternately arranged for the separate plumes to bridge or collide with each other and co-wet into a continuous film out in front of (before workpiece arrival) the orifices (not shown). This could be done using a number of known measures, including pulsing the flow pressure and/or oscillating the individual plumes 3a-3c or their orifices. This collision region would comprise, at least in a short segment, a co-wetted merged film. Typically, though, the plumes of FIG. 2 would beneficially remain separated on average most or all of their flight-time to provide larger working distances D.

One may have more than one row of plumes than the one shown in FIG. 2. For example, one could have a random array of such plumes filling an area of plume emission, with the average plume-to-plume pitch to diameter approximate ratio of 3:1 (e.g., plume diameters=1, plume pitch=3, interplume gap=2). We note for any apparatus embodiment of the invention that the most general application will involve one or more plumes being somewhat curved (along their emitted lengths) and one or more impacting plumes having an angle theta with a work surface. Of course, we include in the scope curved plumes with theta equal to zero as well as straight plumes with any theta-including zero degrees. As before, plume curvature and theta may vary with operative parameters, with gravity, with the purposeful or given ambient flow of any gaseous ambient, or with manipulation of the geometrical relationship of the wand relative to the workpiece. Also included in our scope is theta being close to 90 degrees to the worksurface such that jet impingement is at a very small shearing angle to the surface.

We include in the scope of the invention a plume diameter d or thickness t (or any other dimension or angle) being adjustable as by user-mechanical adjustment, automatic adjustment, or substitution of parts. We also include in the scope of the invention the surrounding of one or more plumes with a flowing or static material (such as enveloping blown air) which encourages the plumes not to break down or become unstable or which favorably changes their shape, angle, velocity or concentration of an agent(s). In the example of blown air, one could easily intersperse (not shown) air-jets between our water plumes to accomplish this. One could also have concentric jets co-axial or collinear with the plume jet or orifice(s) (not shown). Also included in the scope of the invention is the use of catchments, shields or drains utilized to at least one of a) recycle a liquid or constituent thereof, b) prevent a liquid or constituent thereof from migrating (particularly in an airborne aerosol manner or floor-puddling manner) away from the worksite or work surface for any reason.

Additional specific processes to be performed by the inventive device might, for example, also be any of the following:
a) vehicle cleaning, degreasing, deoxidation and/or polishing/sealing;
b) house or window/glazing or tile cleaning;
c) cleaning of sanitary facilities or equipments such as food processing plants, restrooms, surgical sites, meat packing plants, canning facilities;
d) cleaning or washing of buildings, walkways, roadways, signage, trains, buses, planes, ships;
e) decontamination of anything or anyone after a chemical spill or terrorist attack or exposure to a contagion, virus or bacteria;
f) standoff cleaning of high-tension electrical insulators or equipment (for this, one may employ an insulating liquid or deionized liquid);
g) cleaning of electronics, pc boards, integrated circuit wafers or chips, optical components, or articles made by grinding;
h) cleaning of graffiti, soot, bird-droppings, pollen, insect larvae;
i) cleaning of oil-spills or spilled hydrocarbons from inanimate and animate objects and lifeforms;
j) elimination of the use of abrasives as in sandblasting or grit-blasting;
k) elimination of the use of ozone-depleting fluorocarbon or other solvents and gases, particularly for cleaning and coating processes;
l) coating, painting, priming;
m) stripping, paint removal; abrasive processes;
n) cleaning/conditioning or coloring of fabrics, textiles, web-based materials, roll-to-roll materials, clothing (prior art ultrasonic clothes/fabric cleaners are either immersion and/or transducer-contacting);
o) firefighting (enhancement of soak-in and wetting);
p) cleaning or delousing of livestock or the fur/hides thereof;
q) pre-surgical or post-surgical cleaning or preparation of surgeons, patients or associated implements;
r) cleaning or deactivation of toxic chemicals, harmful microbes, harmful viral constituents, anthrax, botulism, Sarin, nerve gas; and
s) cleaning or wet-based processing of living entities such as plants and animals for any beneficial reason such as to kill fungus, kill bacteria, kill virus, or promote a genetic process or treatment known to be enabled or accelerated by ultrasound.

In the case of a high-rise window washing application, human operators may be safety-beneficially displaced and the system may incorporate at least vertical plume scanning means. Transducer arrays are typically extended as described, comprising at least one row of elements or one “equivalent” row even if straight rows are not employed. Individual transducer elements may optionally be operator replaceable. Typically, an average length of a plume (whether straight or curved as by gravity or wand/surface motion) will have a length to average thickness (or diameter) ratio of 1.5:1 to 10,000 to 1, more preferably from 2.0:1 to 1,000:1, and most preferably from about 2.0:1 to 300:1. Typically, the liquid/acoustic wand array itself will have a length/width ratio between 2:1 to 1,000:1, more preferably between 5:1 to 500:1 and most preferably between 8:1 and 100:1. Typically, if multiple plumes/streams are used, their average pitch to average diameter ratio measured at the impact zone on the work-surface would be between 2:1 and 50:1, more preferably from 2.5:1 to 10:1, and most preferably between approximately 3:1 and approximately 5:1. Typically, acoustic transducer arrangements utilized will operate at at least one frequency in the KHz to a few-MHz range. Plume additives may also be utilized that favorably stabilize the plume from breakup, such as surface-tension reducers, for example. These might also do double-duty to support workpiece processing. One may also choose acoustic operating conditions that enhance the stability of the plume(s). An extended transducer array (which may comprise many abutted or overlapped transducers or one really long transducer) may be straight, curved, circular, polygonal, etc. Fluid effluent may be emitted from such an array at variable angles vs. time or variable angles versus position on the array. Flow rates may vary with time, with process substep, with substep progress or degree-of-completion, with acoustic emission, etc. Acoustic parameters may vary with flow and with specific orifice or specific transducer. Automatic and/or manual control of one or more of these parameters is anticipated in various embodiments. Liquids or additives dispatched from a plume may undergo phase changes such as the evaporation of a solvent or the sublimation of dry ice or supercritical CO₂ liquid.

The apparatus may be powered (at least acoustically) by an external electrical power cord, by a battery/fuel-cell pack or even by compressed gas or fluid whose forced flow causes purposeful resonation. A typical acoustic duty-cycle would have the acoustic power on a total of 25%-75% of the time allowing downtime or off-time of 75-25%, possibly for additional cooling, pulse/echo measurements, if any, or rinsing. On-time would typically comprise CW pulses, each CW pulse having multiple waveforms, typically tens of waveforms if not hundreds or thousands. Alternatively, rather than one or more fixed-frequency CW signals, one may utilize chirped or broad-band pulses alone or strung together in extended bursts.

We specifically note that, particularly in the case of CW operation, one preferably utilizes air-backed transducers (item 10 of FIG. 1) and acoustic matching layers to minimize wasted power and maximize efficiency. This is also novel to the invention

Our liquid (more accurately “flowable”) effluent may be heated or cooled as beneficial to the work surface process, step or substep being performed. At least one of the substeps will cause a useful work surface or work-article alteration. Our acoustic pulses may be purposely asymmetric in the known manner in order to suppress cavitation if that is desired. They may alternatively be symmetric and undistorted to enhance cavitation if that is desired. One or more of our substeps may include a spray or aerosol of liquid, particularly the non-acoustic steps. Such a spray or aerosol might be powered by the same transducers and/or by other known pressurized atomizers or nebulizers. A typical spray application would be a rinse or a deposition. The apparatus may include sliders, rollers or other distance-sensors that monitor and/or otherwise physically maintain a desired plume length and/or angle as the workpiece translates and/or rotates relative to it.

III. Acoustic Cleaning System of the Present Invention.

We have taught above that in several preferred modes of operation of our surface treatment or cleaning device, we would arrange for our ultrasonic jet or plume to deliver one or both of acoustical cavitating-action or acoustical non-cavitating action to the work surface or object. Now we provide further detailed arrangements and methods to do one or both of those, separately, sequentially or simultaneously.

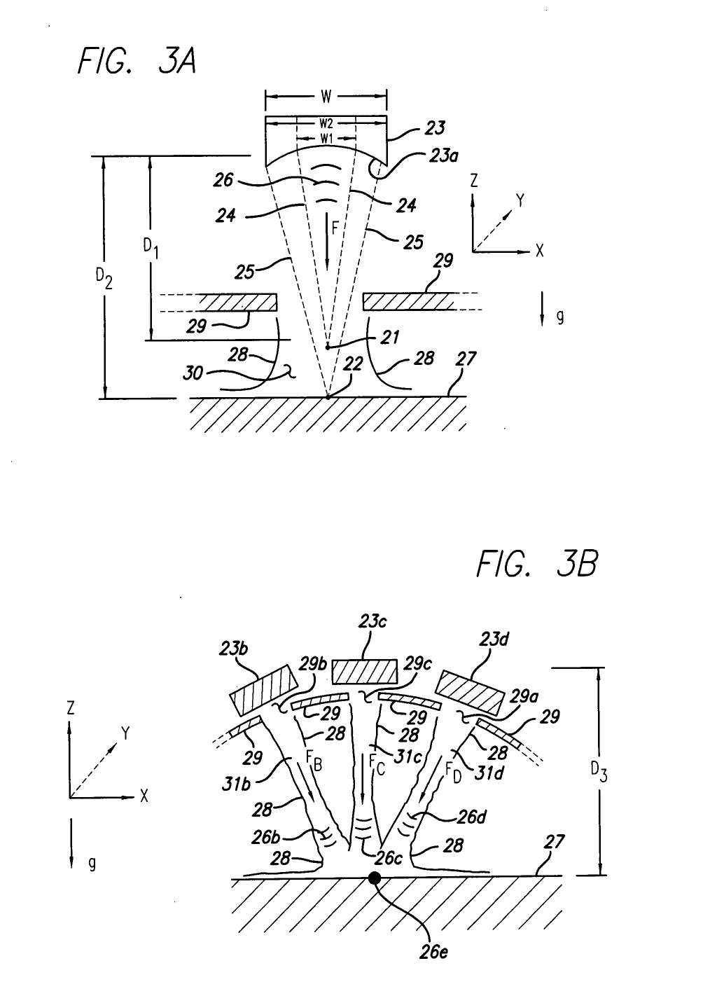

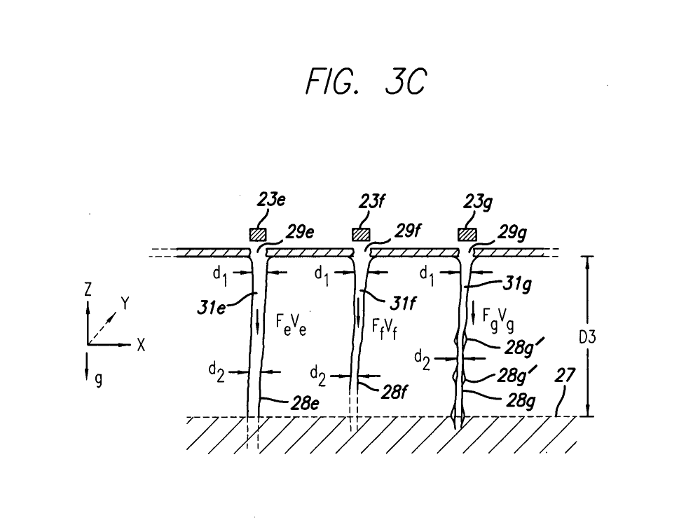

Moving now to our FIG. 3A, we see an acoustic transducer 23 with an emission surface 23a pointed downwards in the −Z direction, parallel to gravity G in this particular setup. Transducer 23 is of overall width W and is shown as having two possible focus points or foci at distal points 21 and 22, respectively. Acoustic waves 26 are depicted traveling downwards toward a work substrate or object 27 to be cleaned or treated. Note that the acoustic waves 26 are propagating through our inventive plume, water for example, into, across and past an aperture or orifice plate 29. Focus point 21 is shown at a distance D1 and having a beam envelope generally described by phantom lines 24. Focus point 22 at further distance D2 is show upon the substrate 27 and is shown as having a beam envelope defined by phantom lines 25. It will be noted that the beam for point 21 emanates from the transducer face 23a with a width W1 whereas the beam for point 22 emanates from the transducer face 23a with a width of W2 that is a large portion of overall transducer width W. This can be accomplished as by having the transducer have two different surface focal radii, one in each width zone (R1 within W1 and R2 outside of W1 but inside of W2).

Note that downward fluid flow is indicated by flow vector F and that the flow F impacts upon the substrate 27 with a meniscus 28 forming on the fluid 30 surface. It will be appreciated that we have already taught that the fluid flow F may be gravity-fed or may be pressurized above ambient pressure with any static, ramped, oscillating, pulsed or varying pressurization scheme desired.

Practitioners of the acoustic arts for medical imaging will be aware that one can make transducers which have a movable (or distributed) focus in the Z-axis in any one or more of several manners.

A mechanically focused transducer, as shown in FIG. 3A, will have a fixed focus if the face 23a has a constant radius, such as might be the case for addressing point 22 on substrate 27. But further, it is known that if such radius of face 23a is not constant, perhaps a blend of a first radius in region W1 and a second different radius in regions within W2 but outboard of W1, then that portion of the transducer will focus on point 21, for example. Thus, the point is that by surface-shape changes of transducer surface 23a, we can create one or more foci that will be focused separately as the transducer operates across full width W or portions thereof. We could also have continuously changing radii on face 23a whereby the focus is distributed along the Z-axis, say from point 21 to point 22. Acousticians will also realize that if one has the entire transducer 23 operating to deliver acoustic power to two or more foci simultaneously, then the total transducer power is accordingly distributed among (split between) those multiple foci.

Acousticians from medical imaging fields will also be aware that one can achieve a movable focus that is movable electronically or electrically. Electronic movement can be implemented by having transducer 23 comprise an annular array transducer with at least some if not all of the ring elements in the array fired with a phase-delay relative to others. This is called electronic beam forming. An advantage of beam forming is electronic movement of the focus (vertically in this example) or laterally and vertically in phased-array acoustic imaging. We discussed above the use of lateral beam scanning as well, such as scanning an acoustic beam inside or upon a plume surface.

Beam forming, regardless of how it is done, gives the user an acoustic amplification factor at the focus compared to at the transducer 23a face in terms of acoustic-intensity. It is a desirable thing to have if one wishes to selectively cavitate or to have higher power-density (even non-cavitation power density) at a distal location such as at remote points 21 and/or 22.

Another method of moving the focus electrically is to have a curved-face transducer 23/23a such that the thickness of the transducer is variable across a width such as across W. By driving the transducer at a higher frequency, one may selectively excite only the thinner transducer regions (such as inside width W1). Alternatively, by driving the transducer at a lower frequency, only the outboard thicker edges of the transducer 23 can be driven. Of course, if the radii or directivity of these portions of surface 23a are different, then the beam is also focused at different locations when this takes place.

We have shown an aperture or orifice plate 29 in FIG. 3A. One benefit of this orifice means is that one can shape the water plume independent of the transducer. Another benefit is that the transducer may be arranged to radiate through the orifice plate 29 (shown) or the orifice plate 29 may mask the edges of the beam from hitting the work surface 27 at all.

Included in the scope of our invention is the integration of the orifice plate with the transducer 23 (not shown in FIG. 3a). For example, a transducer acoustic matching layer could also serve as a water-orifice. Further, the transducer 23 could actually be inserted into a plume below an aperture plate.

We stress that by focus we do not restrict that to a point focus; rather, the focus may instead be a line focus, a curvilinear focus, or a laterally and/or vertically moving focus, for example. It may also be a distributed focus, as mentioned earlier.

For a handheld cleaning device, for example, it would be preferable to have either a distributed focus or a movable focus wherein the moving is such that the focus is maintained at or near the work surface despite a variable throw-distance of the plume as the user's hand moves.

Thus, we already included in the scope of our invention the use of, for example, pulse-echo detection of a transducer/work surface distance such that the device may optionally electronically adjust the focus to be at the surface 27 despite movement of transducer 23.

Moving now to FIG. 3B, we see a multi-plume device of the invention as previously taught. In particular, we see three transducers 23b, 23c and 23d firing through three apertures 29b, 29c, and 29d in orifice plate 29. Note that the three-transducer device is approximately at a distance D3 from a work surface or target-object 27. It will be noted that the three plumes have flows F_{b}, F_{c} and F_{d}, respectively. The various edges or surfaces of each plume are depicted as surfaces 28. We further denote acoustic energies 26b, 26c and 26d being delivered in the respective plumes to a common point or region 26e on work surface 27.

The essential aspect of FIG. 3B is that because we have three separate plumes, each with its own acoustic energy being delivered to common point or region 26e, the acoustic intensity at point or region 26e is essentially the wave-summation of the three separately incoming intensities. This allows us to achieve higher acoustic intensity at distal point or region 26e without necessarily requiring that each transducer 23b, 23c, 23d be itself focused. This is very useful if the plumes are long or of high aspect-ratio as they are shown in FIG. 3B. (shown to have approximate aspect ratios width/length or about 5:1 to 8:1 in this example). It is also useful if the plumes may be curved, as by gravity. We note now that one may vary the time-phasing of the three transducers in relation to each other. This would cause periodic constructive interference on a regular periodic basis despite a somewhat varying distance D3. One might also perform our pitch/catch detection, for example for each of the three transducer/plumes, such that that distance information is dynamically updated in order to maintain a desired relative phasing at point or region 26e. Within the scope of our invention is all manner of relative phase management including fixed relative phases.

Again, we have depicted the device of FIG. 3B as firing its plumes and acoustics downwards in a manner generally parallel with depicted gravity G. This orientation is not a requirement for the invention. In general, if very low flows are desired, one would likely utilize gravity flow; however, we explicitly included in the scope above the use of positive pressurization of the plume(s) to higher velocities such that plumes can be directed at angles to gravity. Further, we also included in the scope the use of surface-tension and capillary forces of liquids and their additives to help shape a plume and/or extract a plume from one or more orifices. We also included the use of flowed gases to direct, scan or shape one or more plumes. We also include the use of acoustic streaming forces to provide beneficial flow-pressurization and/or plume steering/shaping. These features are included in the scope of our invention herein.

Again, the major advantage of the FIG. 3B arrangement is that we get additive acoustic intensities at a distal location such that we can get higher acoustic intensity at the distal location, whether it be for cavitational or non-cavitational cleaning or treating purposes.

Before proceeding to the next Figure, we shall reinforce and add detail for some prior comments regarding cavitation. We taught above that cavitation involves the formation of microbubbles in the liquid. These bubbles can take two general forms, ones that last for only one pressure cycle and ones that last for many pressure cycles. Further, it is known that when cavitation microbubbles form at, upon or near surfaces (work surface 27 for example) those bubbles emit directional fluid jets as they collapse, and it is these jets that can cause erosion and pitting of even hard surfaces. These phenomena are well understood in ultrasonic immersion containers.

Understanding these phenomena, the present inventors specifically anticipate that we will have one or both types of cavitation phenomenon in devices we design to utilize cavitational mechanisms. For example, we may have multicycle cavitation bubbles formed in the falling (jetted) plume. We may also have single-cycle cavitation events in the plume. Further, particularly with distal acoustic intensities being arranged to be higher than transducer-near-field intensities (FIGS. 3A or 3B for example) we may have multi-cycle and/or single cycle cavitation events taking place at, near or upon work surface 27. In particular, we note that work surface 27 will induce the directional jetting we mentioned above. Those cavitational microbubbles will deliver very high localized energy to work surface 27 for cleaning and/or treating purposes, in a manner similar to that of an immersion ultrasonic cleaner.

We explicitly note that we can have cavitational bubbles or microbubbles that form in the plume but that get delivered to the surface, whereupon they can contribute to our energetic cleaning or treating processes. Some or all of these microbubbles may be nonjetting while in the plume but become jetting when delivered to the surface. We note that the velocity of the plume determines how much closer a cavitation event gets to surface 27 before it expires or dies out. So we anticipate, in various embodiments of the invention, arrangements wherein the plume velocity is selected, at least in part, to maximize delivered cavitational events to the surface. Thus, some applications might utilize very fast plumes or streams close to, equal to or even faster than sonic velocities in water. In such a manner, one might also gain benefit from the known benefits of treating or cleaning using near-sonic or supersonic liquid streams.

A second competing mechanism that could prevent distal cavitation is the acoustic lossiness and scatter in the beam (plume). It is possible to squelch the ability of the plume to deliver acoustical energy to surface.27 if massive cavitation or microbubbling is happening near the face of the transducer or in the mid-beam regions. By “microbubbling” we mean gas-dissolution, whether or not it is acoustically aided or pressure-drop aided as it passes into or along the plume. Such microbubbles become cavitational seeds for one or both of free-space cavitational oscillations or surface-centric jetting cavitation. Thus, such microbubbles, whether cavitating or not, could limit power delivery to the work surface 27. Excess addition of agents could also cause so much attenuation that cavitation at the surface becomes impossible.

Moving now to FIG. 3C, we depict a previously taught phenomenon, that of manipulating the plume or stream using the carried acoustics and/or utilizing the plume/stream to amplify or otherwise favorably alter the acoustics propagating therein.

Acousticians will be aware of two phenomena as follows. The first phenomenon is called streaming-pressure and it is the effect of propagating acoustics in liquids to drag or pump the liquid. Streaming pressures, for high-intensity ultrasound, are high enough to jet water feet in height. The second phenomenon is called radiation-pressure and in particular we mean acoustic radiation pressure upon particles suspended (or carried) in the liquid. That radiation pressure typically attempts to push the solid particle through the liquid.

In cases of a viscous liquid with particles in it, one has both forces working. The particles are directly pushed because of the acoustic radiation pressure, but they drag the liquid along with them due to the liquid viscosity. Secondly, and independently to a substantial degree for low particle densities, we also have the acoustic beam pushing the liquid itself directly.

In FIG. 3C, we again see an orifice plate 29 having three orifices 29e, 29f, and 29g. The three orifices have mating acoustical transducers 23e, 23f and 23g. From the three different transducer/orifice sets, we see three different plumes emanating downwards in the −Z direction which just happens to be parallel with gravity vector G.

The plume 31ₑ from transducer/orifice set 23e/29e is shown as having a velocity Vₑ and a flow Fₑ, an upper diameter d1 and a lower distal diameter d2. Like-wise we see the plume 31f from transducer/orifice set 23f/29f having velocity V_{f} and flow F_{f} with similar diameters, and the plume 31g from transducer/orifice set 23g/29g with velocity V_{g} and flow F_{g} and similar diameters. Note that we have depicted a phantom work surface 27 at a throw-distance or working-distance of D3. The outer liquid/air surfaces or interfaces of the three plumes 31e-31g are depicted as 28e, 28f, and 28g, accordingly.

The first plume 31e, assuming all the plumes are round or generally cylindrical in nature along the Z-axis, is depicted, at least over distance D3, as having a diameter d1 and d2, which does not hugely change as it falls or is propelled through distance D3. Fluidics practitioners will be well-aware that Rayleigh instabilities will, at some distance D3, cause any such plume to become disfigured, non-uniform, and break up into droplets or globules due to surface-tension driven forces. However, it is known that measures that can help keep the plume together for larger distances D3 include, for example, using a more viscous liquid, using laminar flow conditions, or using high velocities with a properly shaped orifice, using or causing low-surface tensions in the fluid, and minimizing drag with the ambient.

Moving now to the second plume 31f of FIG. 3C, that emitted by transducer/orifice set 23f/29f, we see a plume which is depicted as narrowing in diameter d more rapidly than that of the plume 31e. As we have previously taught, this may be caused by the acoustic radiation or pressure effects on the liquid (or particles in the liquid). In other words, the acoustic waves coming out of transducer cause the plume to be pushed even faster downwards such that it is stretched in length. This results in a plume narrowing away from the orifice 29f. This phenomenon can have some very beneficial effects for our invention. The first is that the acoustic intensity may be amplified as is a known phenomenon for acoustic “horns” that have necked-down components. This means the possibility of achieving distal higher intensity, possibly even with the unfocused transducer 23f depicted. A second potential benefit now is that we can somewhat propel the beam (if not also laterally deflect it) as if we had changed the fluid pressure. Within our inventive scope is a device wherein none, some or all of the pumping action for the plume comes from the acoustic transducer 23f streaming action.

Moving now to the third and rightmost plume 31g in FIG. 3C, that emanating from transducer/orifice 23g/29g, we see a plume similar to the previous plume 31f discussed above. However, we depict in the plume 31g a number of surface features 28g′. These are features or surface undulations in the plume where nodes and anti-nodes of the passing acoustics can be visualized. They would be particularly evident wherein one has standing nodes or antinodes at distances below the transducer 23g or at points between 23g and surface 27, assuming acoustic reflections are taking place from surface 27.

One reason for pointing out these nodes is that the present inventors expect that these nodes, in one or both of their moving or stationary states, will stabilize the plume with respect to Rayleigh instabilities. This phenomenon is exceedingly attractive if it allows for longer throw-distances or reduced fluid consumption.

The present inventors wish to reemphasize at least two types of cleaning or treating mechanisms deliverable by the invention. The first is cavitational. The second is non-cavitational. It is known that acoustic waves passing relatively parallel to a dirtied surface can, by liquid-phase motions alone, scrub off such microparticles. This has been commonly deemed the (non-cavitating) immersion “megasonic” effect in the semiconductor industry and has been utilized to immersion-clean semiconductor wafers and glass micromasks for decades now. Using our invention herein, we can deliver similar megasonic-style cleaning action without the prior art required immersion of the workpiece. We can do this two ways. The first way is to impact the work surface 27 at a small almost tangential angle with our streams or plumes. The second way is to allow impacting acoustical energy to be redirected or mode-converted from essentially work surface-nonparallel plumes (i.e. they have some angle with the work surface, say a few degrees or more). Mode conversion is a known phenomenon that has critical angles that can be calculated. Further, depending on the work surface material and surface features, the work surface may itself encourage such mode conversion and/or redirection of acoustical energy. We include in the scope of our invention mode conversions wherein the starting mode is in the plume and the resulting mode is either in the plume or injected into the workpiece. Further, the acoustic modes in the plume may be injected into the workpiece material as a known function of impedance-differences and angle of incidence. Previously, we described how the meniscus shapes at the plume impact points on the work surface can spread and/or redirect treatment ultrasound.

Note also that for an inventive multi-stream or multi-plume device, we may also mechanically move or scan one or more orifices relative to one or more transducers. This option could also encompass having fewer transducers than orifices or having only one transducer serving several orifices. Obviously, one could scan either the transducer(s) or orifices(s) relative to the other and/or relative to a workpiece. We have shown the simplest plume arrangements herein, but it will be noted that any useful 1-D, 2-D or 3-D plume geometries may be practiced, including those that emit plumes and/or ultrasound in or along one, two or more directions or radii or that scan or sweep through one or more angles. The device may have one or more transducers that emit substantially all or most of their acoustic energy through one or more orifices (shown) or may have transducer(s) which either have some of their acoustic output masked (as by plate 29 or orifice 29b-29g, for example) or as by having an orifice occasionally scanned in front of said transducer whereupon the acoustics are unmasked. The invention utilizes defined streams or plumes that are most easily formed using an orifice or aperture. However, we do not limit the scope of the invention to requiring an orifice. An example of a no-orifice implementation would be wherein the stream is created emanating from a fluid pool using only acoustical energy, in a manner known to those researching new ways of inkjet and biojet printing.

We have shown the flowing plume and ultrasound energy having a substantially uninterrupted path from transducer to workpiece, perhaps except for some losses in the plume due to, for example, additives or bubbles or modal changes/amplification. Alternatively, one may have, for example, a metal screen over the orifice and have the plume and ultrasound pass through it. This is particularly possible in cases wherein the acoustic wavelength in the liquid is longer than the pitch or spacing of the screen features. Such a screen, for example, could be used to electrically charge the plume or to carry plume electrical current in an eletroconversion or electroplating process.

We have previously mentioned the use of various frequencies with the invention. Two particular likely scenarios include higher frequencies in the megahertz range for our megasonic (non-cavitational) approach and lower frequencies in the tens or hundreds of kilohertz range for our cavitational approach. Specifically included in the scope of the invention is the use of one or more transducers which, alone or together, offer multi-frequency operation. By “multi-frequency” we mean either or both of simultaneous operation or sequential operation. Such transducers frequently are broadband in nature and have one or more acoustic and one or more electronic matching layers and networks respectively. If one is trying to cavitate, it is frequently attractive to operate in continuous wave mode (CW mode) to initiate and sustain cavitation-particularly at the lower frequencies of tens to hundreds of kilohertz.

Care should be taken, if appropriate, to make sure that the device has no irritating audible tones such as might be emanating from the transducer or from its power supply. Such tones may be primary, sub-harmonic or super-harmonic tones, but will most often be sub-harmonic or primary tones or frequencies. Such tones, in manners known to the acoustic industrial equipment art, may be damped out physically or electronically or may be avoided entirely by a different choice of primary operating frequency or as by real-time variation of the operating frequency.

The present inventors anticipate that the treating/cleaning apparatus, depending on application, may be operated from a fixed or moving mounting, or perhaps both. As an example, in a carwash, the car is moved on a floor chain such that the inventive apparatus, particularly if it has a laterally extended plume, may not need to be moved relative to the building frame. The same argument can be made for a glazing-cleaning apparatus that goes up and down the outside of skyscrapers to clean the windows. Such devices could easily be automatic and not require direct hands-on manual operation or intervention. On the other hand, if the workpiece is not itself passed by the inventive apparatus as by translation or rotation, then one may elect to physically scan the apparatus, in at least one dimension, direction or axis, across or around the workpiece. The present inventors give as an example of this an apparatus used to clean a large stationary irregularly shaped object such as a fighter jet on an aircraft carrier. We also include in the inventive scope the use of robots to scan either or both of the inventive apparatus and/or the workpiece.

The present inventors anticipate applications wherein, if the liquid plume is not serving a waveguide function, then measures to keep the beam in the flow plume if one or both of them move or are moved might be necessary for large movements. Along these lines, we include in the scope of the invention acoustic beams that are aligned or realigned to their plume and/or plumes that are aligned or realigned to their acoustic beams. Knowledge of the orientation or positioning of one of those allows the second to be aligned to it, perhaps even in real time for scanning systems. Thus, for example, we may have optical or video sensors determine plume geometry/orientation and have that information fed to the acoustic emitter such that it be steered in the same direction. Alternatively, one may slew the acoustic beam mechanically or electronically and have the movable plume follow accordingly, given the pointing information. We had earlier mentioned using the acoustic beam itself to sense a parameter of the plume or workpiece. We hereby now explicitly include in that acoustic sensing of a plume parameter related to beam geometry, positioning or pointing. Typically, such detected information would be utilized in a feedback loop.

We emphasize that by “scan” we mean that, ultimately, at least one plume is moved relative to a workpiece, regardless of whether the apparatus, the plume or the workpiece is actually moved or how it is moved.

Another attractive application for the invention is in a vehicle or carwash wherein one desires to clean the inside of complex wheels, particularly “mag” wheels or spoked wheels. This application may utilize a side-shooting implementation of the apparatus

IV. Additional Considerations.

For the sheet-shaped or 2-D (flat or curvilinear) plume, a focused or phased-array transducer may be used to steer within the self-limiting thickness confines of that plane (and preferably also get our amplification/summation). This could be just one generally flat sheet or plume, but it is still in the spirit of amplification/summation. In the thin thickness dimension of the plane, it is most likely that the plume plane acts as a waveguide in that thickness direction only.

Agents may be added, such as detergents, solvents, coatings, etchants, plating solutions, microbubbles, microbubble nuclei (evolved gas content), abrasives, and the like for aiding in the cleaning.

The plume/stream velocity can have any value of zero or greater, positive or negative (e.g., upward or downward). This includes subsonic, near-sonic and sonic in the limit.

A variety of applications of the acoustic cleaning system disclosed herein are possible, including, without limitation, cleaning buildings, glass, masonry, facades, equipment, components, tools, vehicles, animals, people, graffiti, as well as conversion coating such as anodization, which may utilize a biased, charged or electrically conductive fluid, electroless plating, electroplating, toxic cleanup, painting, stripping, abrading, degreasing, etching, and the like.

The plume temperature may be favorably manipulated to enhance treatment

The workpiece may be human or animal, but one would not necessarily cavitate in that case unless one wants to destroy/remove tissue as for wound cleaning, skin-layer stripping, etc. Some medical applications may not require cavitation, such as one which injects ultrasound for subsurface beneficial or therapeutic heating/

Two or more impinging streams may be joined to form a bridging meniscus, thereby aiding the treatment of between-stream gaps.

While the invention has been described in detail with reference to preferred embodiments thereof, it will be apparent to one skilled in the art that various changes can be made, and equivalents employed, without departing from the scope of the invention. Specific examples of the invention described herein are not exclusive of other applicable structures and methods.

What is claimed is:

1. An apparatus for treating or cleaning a workpiece or subject that utilizes acoustic energy carried to the workpiece through at least one flowable stream directed at, upon or into said workpiece, the apparatus comprising:
a flowable medium such as a liquid which can be flowed as at least one stream or plume at, upon or into a workpiece from a flowable-medium flow-emitter or orifice;
a source of ultrasonic, acoustic or vibratory energy acoustically coupled into at least one such stream or plume at one or more points in a manner allowing at least part of said coupled acoustic energy to propagate to the workpiece through at least part of one said stream or plume;
a workpiece, subject or treatment object situated, for at least a period, in the range of at least one said stream or plume allowing for impingement or wetting by said acoustic-energy carrying stream of said workpiece;
the impinging or wetting stream(s) or plume(s) carrying said ultrasonic energy during at least a portion of an impingement or wetting period;
the workpiece impingement angle or angles including at least one value between 0 and 180 degrees; and
the angle of the plume or average plume-angle at at least one position on the plume being between 0 degrees and 180 degrees to local gravity, whether natural or artificially induced or a vector sum thereof.

2. The apparatus of claim 1 wherein an impingement angle of an impinging or wetting stream is substantially 90 degrees or orthogonal to a local workpiece portion or surface.

3. The apparatus of claim 1 wherein an impingement angle of an impinging or wetting stream is between 180 and 0 degrees such that the impinging flow is at least partly parallel or has a component parallel to a workpiece surface portion.

4. The apparatus of claim 1 wherein an impingement angle of at least one said impinging or wetting stream or plume is scanned or varied as by at least one of:
motion of the workpiece;
motion of the apparatus;
movement of a plume or stream relative to the apparatus as by an impacting gas flow on the plume or stream;
movement of a plume or stream by changing the magnitude or direction of emission pressure forcing the flowable medium toward the workpiece or out of an orifice;
movement of a plume or stream by changing a shape or orientation of an emission orifice or by changing a flow property of an emitted medium;
movement of a plume or stream by an influence of the acoustical energy passing through or into the plume or stream; or
movement of a plume or stream by electrostatic or magnetic deflection.

5. The apparatus of claim 1 wherein a plume's or stream's acoustic intensity or acoustic power measured nearer or at a workpiece and further from or distal from at least one acoustic emission transducer is higher than that nearer that transducer's face, said plume(s) or stream(s) also including the post-impingement wetted-out portion on the workpiece surface as well as any region along or within flowing plumes or streams whereat two or more said streams or plumes fluidically combine together.

6. The apparatus of claim 5 wherein acoustic amplification takes place due to at least one plume or stream having a variable shape along its emission length.

7. The apparatus of claim 5 wherein some acoustic reinforcement or summation takes place due to two or more streams or plumes, each having its own propagating acoustical energy, fluidically combining before or upon workpiece arrival causing the stream combination region to receive acoustical energy from both such streams.

8. The apparatus of claim 5 wherein one or more focused transducer(s) is directed into or coupled into a stream(s) or plume(s), said focal intensity or power maximum being at or near said focus at a focal distance along the stream or plume flow path.

9. The apparatus of claim 5 wherein acoustical energy emitted from a transducer or that propagating in or along at least one stream or plume at least partially changes vibratory mode or is at least partially injected into the workpiece subsurface before or after its arrival at the workpiece.

10. The apparatus of claim 5 wherein a mechanically focused transducer has at least one focus arranged to be at or near a workpiece distance or workpiece portion to be treated for at least a useful period.

11. The apparatus of claim 5 wherein an electronically focused transducer has at least one focus arranged to be at or near a workpiece distance or workpiece portion to be treated for at least a useful period.

12. The apparatus of claim 5 wherein at least one transducer fires through an orifice or aperture.

13. The apparatus of claim 1 wherein two or more emitted plumes or streams merge, flow together or co-wet each other such that they mutually form a third plume or stream having a flow substantially being the sum of the two separate merging flows.

14. The apparatus of claim 13 wherein the two or more stream's flowing fluids mix or combine one or more of: a) before workpiece impingement, b) at the workpiece impingement location, c) after their substantially separate workpiece impingement when their redirected flows co-wet or run together on a workpiece portion or surface.

15. The apparatus of claim 13 wherein said two or more plumes or streams have their respective propagating acoustic energies substantially added together such that a combined or merged plume or stream then propagates the combined acoustical energy; said plumes or streams combining or merging at any point after their emission or during or after their workpiece impingement.

16. The apparatus of claim 1 wherein two or more plumes direct both flowable medium or liquid and acoustical energy to a workpiece point or region, the acoustical energies being substantially additive or vector-summed in a constructive or destructive manner depending on relative phased operation of the transducers, relative lengths of one or more plumes, and one or more impingement or stream merging angles.

17. The apparatus of claim 16 wherein the distal or remote acoustic intensity or power near or at a workpiece is higher than that at the face of at least one acoustic emitter-face of the apparatus, thereby achieving an amplification or intensifying effect.

18. The apparatus of claim 16 wherein there are between two and six plumes or streams at a given moment of operation, and some or all of those plumes are delivering flowable medium and acoustical energy to a substantially common workpiece point or region.

19. The apparatus of claim 16 wherein the acoustics coupled into said plumes is at least one of a) focused mechanically or electronically or b) unfocused.

20. The apparatus of claim 1 wherein one or more plumes or streams has an average diameter-to-length or average thickness-to-length ratio of between 1:1 to 1:20 at least before it impinges or before any stream merging.

21. The apparatus of claim 20 wherein the acoustics coupled into said plume or plumes is at least one of a) focused mechanically or electronically or b) unfocused.

22. The apparatus of claim 1 wherein a plume or stream has an average diameter-to-length or average thickness-to-length ratio of greater than 1:1.

23. The apparatus of claim 1 wherein any stream or plume-carried or impinged acoustical energy causes any one or more of:
a) a stretching, tapering or shaping of a plume or stream;
b) an increase in a flow velocity of at least part of a plume or stream;
c) a change in a plume or stream shape or dimension resulting in beneficial acoustic amplification or mode-conversion;
d) a merging or wetting behavior change between plumes or between a plume and a workpiece;
e) nucleation, generation or maintenance of microbubbles or cavitation events; or
f) an acoustically enabled or accelerated cleaning or treating process.

24. The apparatus of claim 1 wherein acoustical energy is arranged to impact the worksurface at an angle other than 90 degrees or other than normal and providing at least one of: a) acoustic mode-conversion, b) acoustic workpiece injection, or c) lateral workpiece scrubbing motions at the workpiece surface, the plume impingement angle not necessarily being the same as the acoustics impingement angle.

25. The apparatus of claim 1 wherein operation is in at least one of a non-cavitational mode or a cavitational mode at at least one workpiece surface region or point for at least a period.

26. The apparatus of claim 1 wherein cavitation occurs at least one of in a plume or in the flowable media at, near or upon the workpiece.

27. The apparatus of claim 1 wherein acoustic nodes or antinodes in a plume at least one of: a) are visible or measurable at substantially static positions in the plume, b) are dynamically moved through or are moving through various positions or distances in or along the plume, or c) serve to stabilize or control a desired shape, length or behavior of the plume before or after impingement.

28. The apparatus of claim 1 wherein plume angle or an average plume angle to gravity is between 0 and 180 degrees and that angle is the angle relative to gravity measured at one of: a) at an orifice exit, b) at the plume's impingement region, gravity being natural or artificially induced gravity or acceleration or c) a vector-sum of both.

29. The apparatus of claim 1 wherein the application is in a weightless environment, wherein the gravity vector, natural or artificial, is essentially zero in total magnitude.

30. The apparatus of claim 1 wherein at least some acoustics propagated within one or more plumes at least one of: a) contains a fixed frequency component, b) contains two or more frequency components, c) is narrow-band in nature, d) is broad-band in nature, e) contains switchable frequencies, f) contains variable frequencies, g) contains acoustical energy of fixed intensity or power, g) contains acoustical energy of variable intensity or power, h) contains a ramped frequency component, i) contains a frequency/intensity combination known to be capable of surface microscrubbing, j) contains a frequency/intensity combination known to be capable of cavitation or to avoid cavitation, k) is useful for workpiece cleaning or treating, l) is employed in sensing any parameter related to the operation of the device or the workpiece, m) contains acoustics which are controlled using a feedback loop of any type, n) contributes to a plume or workpiece sensing task utilizing a pitch-catch or pulse-echo technique, o) is of a continuous wave or CW nature, p) is of a pulsed nature, or q) is adjusted with respect to a first acoustical parameter in response to a measurement of a plume or workpiece second parameter.

31. The apparatus of claim 1 wherein, given at least one acoustic beam and a beam-carrying plume or stream, a position or orientation parameter of one of those is sensed and used to position, aim or orient the other, thereby assuring that the beam remains substantially inside of or within the confines of the plume or stream at least for applications wherein the plume or stream does not itself steer, confine or provide waveguiding for the acoustic beam.

32. An apparatus for treating or cleaning a workpiece or object that utilizes acoustic energy carried to the workpiece through two or more flowable streams or plumes substantially commonly directed at or upon a workpiece or site thereon for at least a period, the apparatus comprising:
a flowable medium that can be flowed at or upon a workpiece from or out-of two or more plume or stream orifices, flow-apertures or flow-sources;
at least one source of ultrasonic, acoustic or vibratory energy acoustically coupleable into two or more such streams or plumes at one or more points on each said stream or plume in a manner allowing at least part of said coupled acoustic energy to propagate to the workpiece through its respective stream or plume or through two or more plumes;
a workpiece or treatment object situated, for at least a period of time, in the range of the commonly directed streams or plumes allowing for impingement of said collective stream or plume while carrying their collective acoustic energy upon or into said workpiece; and
the workpiece thereby being cleaned or treated by two or more co directed plumes or streams, two or more of which carry co-directed ultrasonic energy which is temporally phased, at least for useful treatment periods, to be constructively interfering or additive.

33. The apparatus of claim 32 wherein said constructive interference is arranged, controlled or caused by at least one of:
a) physical distances or angles between transducers and workpieces;
b) time-phased operation of at least one transducer or acoustic emitter relative to at least a second one;
c) the length of one or more plumes; or
d) the unsynchronized or unphased operation of two or more transducers relative to each other thereby allowing for periodic or pseudorandom constructive phase overlap.

34. The apparatus of claim 32 wherein multiple plumes allow for having a distal or workpiece acoustic intensity or power higher than that at a transducer face or emission surface.

35. The apparatus of claim 32 wherein acoustic amplification or vector-summation is achieved.

36. The apparatus of claim 32 wherein cavitation is achieved at a workpiece location, in a plume, or both.

37. The apparatus of claim 32 wherein propagating acoustical energy in a plume at least one of: a) changes the shape of a plume, b) tapers a plume, c) increases or changes a flow rate of a plume, d) beneficially affects a stability of a plume, e) avoids Rayleigh breakup of a plume, f) undergoes amplification or mode-conversion in a plume, or g) creates the plume.

38. The apparatus of claim 32 wherein the plume angle or average plume angle to gravity is between 0 and 180 degrees and that angle is the angle relative to gravity at least one of: a) at the orifice exit or b) at the plume impingement region, gravity being natural or artificially induced gravity or acceleration or a vector-sum of both.

39. The apparatus of claim 32 wherein the application is in a weightless environment wherein the gravity vector, natural or artificial, is essentially zero in total magnitude.

40. The apparatus of claim 32 wherein the emanating acoustics within one or more plumes at least one of: a) contains a fixed frequency component, b) contains two or more frequency components, c) is narrow-band in nature, d) is broad-band in nature, e) contains switchable frequencies, f) contains variable frequencies, g) contains acoustical energy of fixed intensity or power, h) contains acoustical energy of variable intensity or power, i) contains a ramped frequency component, j) contains a frequency/intensity combination known to be capable of surface microscrubbing, k) contains a frequency/intensity combination known to be capable of cavitation or to avoid cavitation, l) is useful for workpiece cleaning or treating, m) is employed in sensing any parameter related to the operation of the device or the workpiece, n) contains acoustics which are controlled using a feedback loop of any type, o) contributes to a plume or workpiece sensing task utilizing a pitch-catch or pulse-echo technique, p) is of a continuous wave or CW nature, q) is of a pulsed nature, or r) is adjusted with respect to a first acoustical parameter in response to a measurement of a plume or workpiece second parameter.

41. The apparatus of claim 32 wherein, given at least one acoustic beam and a beam-carrying plume or stream, a position or orientation parameter of one of those is sensed and used to position, aim or orient the other, thereby assuring that the beam remains substantially inside the confines of the plume or stream at least for applications wherein the plume or stream does not itself steer the acoustic beam by acoustic waveguiding action.
